(19) United States
(12) Patent Application Publication
(10) Pub. No.: US 2017/0300303 A1
(43) Pub. Date: Oct. 19, 2017

(54) Linear Programming Formulation for Incremental Layout in a Graphical Program

(71) Applicant: NATIONAL INSTRUMENTS CORPORATION, Austin, TX (US)

(72) Inventors: Anand Kodaganur, Bangalore (IN); Ashwin Prasad, Bangalore (IN); Rajneesh Lakkundi, Bangalore (IN)

(21) Appl. No.: 15/490,280

(22) Filed: Apr. 18, 2017

(30) Foreign Application Priority Data
Apr. 18, 2016 (IN) 201611013509

(51) Int. Cl. G06F 9/44

(52) U.S. Cl. CPC G06F 8/34; G06F 8/35

(57) ABSTRACT

Various embodiments of a system and method for a linear programming formulation for incremental layout for a graph in a graphical program are described. A graphical programming development environment or other software application may be operable to automatically analyze a block diagram of a graphical program, e.g., in order to determine objects present in the block diagram, as well as their initial positions within the block diagram. The graphical programming development environment may then automatically re-position various ones of the objects in the block diagram. In various embodiments, the objects may be re-positioned so as to better organize the block diagram or enable a user to more easily view or understand the block diagram. The graphical programming development environment may impose one or more constraints on the re-positioning so as to ensure that the resulting modified block diagram is similar to the original block diagram.

### PRIORITY DATA

This application claims benefit of priority to Indian Patent Application No. 201611013509, titled “Linear Programming Formulation for Incremental Layout in a Graphical Program,” filed Apr. 18, 2016, whose inventors were Anand Kodaganur, Ashwin Prasad, and Rajneesh Lakkundi, and is incorporated by reference as though fully set forth herein.

### FIELD OF THE INVENTION

The present invention relates to the field of graphical programming, and more particularly to a system and method for a linear programming formulation for incremental layout for a graph in a graphical program.

### DESCRIPTION OF THE RELATED ART

Traditionally, text-based programming languages have been used by programmers in writing application programs. Many different text-based programming languages exist, including BASIC, C, C++, Visual C++, Java, FORTRAN, Pascal, COBOL, ADA, APL, etc. Increasingly, computers are required to be used and programmed by those who are not highly trained in computer programming techniques. When traditional text-based programming languages are used, the user's programming skills and ability to interact with the computer system often become a limiting factor in the user's efficiency of creating a computer program.

Graphical programming development environments that enable a user to create a program in a graphical manner without necessarily writing source code in a text-based programming language have been developed. Graphical programming development environments enable a user to create a software program by including a plurality of nodes or icons in a block diagram and interconnecting the nodes or icons, e.g., such that the interconnected plurality of nodes or icons visually indicates functionality of the resulting software program (called a “graphical program”). The resulting interconnected nodes may visually indicate a function or process performed by the graphical program during its execution.

Graphical programming has become a powerful tool available to programmers. Graphical programming development environments such as National Instruments Corp.'s LabVIEW product have become very popular. Tools such as LabVIEW have greatly increased the productivity of programmers, and increasing numbers of programmers are using graphical programming development environments to develop their software applications. In particular, graphical programming tools are being used for applications such as test and measurement, data acquisition, process control, man machine interface (MMI), supervisory control and data acquisition (SCADA) applications, modeling, simulation, image processing/machine vision applications, and motion control, among others.

### SUMMARY OF THE INVENTION

Various embodiments of a system and method for a linear programming formulation for incremental layout for a graph in a graphical program are described. A graphical programming development environment or other software application may be operable to automatically analyze a block diagram of a graphical program, e.g., in order to determine objects present in the block diagram, as well as their initial positions within the block diagram. The graphical programming development environment may then automatically re-position various ones of the objects in the block diagram (e.g., when one or more nodes of the block diagram are resized). In various embodiments, the objects may be re-positioned so as to better organize the block diagram or enable a user to more easily view or understand the block diagram. The graphical programming development environment may impose one or more constraints on the re-positioning so as to ensure that the resulting modified block diagram is similar to the original block diagram.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an example of a computer system that may execute a graphical programming development environment application that implements the automatic arrangement of objects in a graphical program block diagram;

FIG. 2A illustrates an exemplary instrumentation control system 100;

FIG. 2B illustrates an exemplary industrial automation system 160;

FIG. 3 is a block diagram representing one embodiment of the computer system illustrated in FIGS. 1, 2A, and 2B;

FIG. 4 is a flowchart diagram illustrating one embodiment of a method for automatically organizing a block diagram of a graphical program;

FIG. 5 illustrates an example of a graphical program block diagram before it has been automatically organized by the graphical programming development environment; and

FIG. 6 illustrates an example of how the block diagram of FIG. 5 may appear after it has been automatically organized by the graphical programming development environment according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference

The following references are hereby incorporated by reference in their entirety as though fully and completely set forth herein:

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment.”

U.S. Pat. No. 6,173,438 titled “Embedded Graphical Programming System,” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Pat. No. 7,210,117 titled “System and Method for Programmatically Generating a Graphical Program in Response to Program Information,” filed Dec. 20, 2000.

U.S. Patent Application Publication No. 20050268173 (Ser. No. 10/843,107) titled “Programmatically Analyzing a Graphical Program by Traversing Objects in the Graphical Program,” filed May 11, 2004.

U.S. Pat. No. 8,479,218 titled “Automatically Arranging Objects in a Graphical Program Block Diagram,” filed Jul. 9, 2007.

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected blocks or icons, wherein the plurality of interconnected blocks or icons visually indicate functionality of the program.

The following provides examples of various aspects of graphical programs. The following examples and discussion are not intended to limit the above definition of graphical program, but rather provide examples of what the term “graphical program” encompasses:

The blocks in a graphical program may be connected in one or more of a data flow, control flow, and/or execution flow format. The blocks may also be connected in a “signal flow” format, which is a subset of data flow.

Exemplary graphical program development environments which may be used to create graphical programs include Lab VIEW®, DasyLab™, DiaDem™ and Matrixx/SystemBuild™ from National Instruments, Simulink® from the MathWorks, VEE™ from Agilent, WiT™ from Coreco, Vision Program Manager™ from PPT Vision, SoftWIRE™ from Measurement Computing, Sanscript™ from Northwoods Software, Khoros™ from Khoral Research, SnapMaster™ from HEM Data, VisSim™ from Visual Solutions, ObjectBench™ by SES (Scientific and Engineering Software), and VisiDAQ™ from Advantech, among others.

The term “graphical program” includes models or block diagrams created in graphical modeling environments, wherein the model or block diagram comprises interconnected blocks or icons that visually indicate operation of the model or block diagram; exemplary graphical modeling environments include Simulink®, SystemBuild™ VisSim™, Hypersignal Block Diagram™, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected blocks are often referred to as the block diagram portion of the graphical program.

Block—In the context of a graphical program, an element that may be included in a graphical program. A block may have an associated icon that represents the block in the graphical program, as well as underlying code or data that implements functionality of the block. Exemplary blocks include function blocks, sub-program blocks, terminal blocks, structure blocks, etc. Blocks may be connected together in a graphical program by connection icons or wires.

The blocks in a graphical program may also be referred to as graphical program nodes or simply nodes.

Wire—a graphical element displayed in a diagram on a display that connects icons or nodes in the diagram. The diagram may be a graphical program (where the icons correspond to software functions), a system diagram (where the icons may correspond to hardware devices or software functions), etc. The wire is generally used to indicate, specify, or implement communication between the icons. Wires may represent logical data transfer between icons, or may represent a physical communication medium, such as Ethernet, USB, etc. Wires may implement and operate under various protocols, including data flow semantics, non-data flow semantics, etc. Some wires, e.g., buffered data transfer wires, may be configurable to implement or follow specified protocols or semantics.

Wires may indicate communication of data, timing information, status information, control information, and/or other information between icons. In some embodiments, wires may have different visual appearances which may indicate different characteristics of the wire (e.g., type of data exchange semantics, data transfer protocols, data transfer mediums, and/or type of information passed between the icons, among others).

Graphical Data Flow Program (or Graphical Data Flow Diagram or Data Flow Diagram)—A graphical program or diagram comprising a plurality of interconnected blocks, wherein at least a subset of the connections among the blocks visually indicate that data produced by one block is used by another block. A LabVIEW VI is one example of a graphical data flow program. A Simulink block diagram is another example of a graphical data flow program.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators.

Input Control—a graphical user interface element for providing user input to a program. An input control displays the value input the by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

Subset—in a set having N elements, the term “subset” comprises any combination of one or more of the elements, up to and including the full set of N elements. For example, a subset of a plurality of icons may be any one icon of the plurality of the icons, any combination of one or more of the icons, or all of the icons in the plurality of icons. Thus, a subset of an entity may refer to any single element of the entity as well as any portion up to and including the entirety of the entity.

Various embodiments of a system and method for a linear programming formulation for incremental layout for a graph in a graphical program are described. A graphical programming development environment or other software application may be operable to automatically analyze a block diagram of a graphical program, e.g., in order to determine objects present in the block diagram, as well as their initial positions within the block diagram. The graphical programming development environment may then automatically re-position various ones of the objects in the block diagram (e.g., when one or more nodes of the block diagram are resized). In various embodiments, the objects may be re-positioned so as to better organize the block diagram or enable a user to more easily view or understand the block diagram. The graphical programming development environment may impose one or more constraints on the re-positioning so as to ensure that the resulting modified block diagram is similar to the original block diagram.

In various embodiments, any kind of software application may implement the automatic arrangement/re-positioning of the objects in the graphical program block diagram. For example, in some embodiments, a graphical programming development environment (e.g., a software application that enables users to develop graphical programs) may implement the automatic arrangement of the objects.

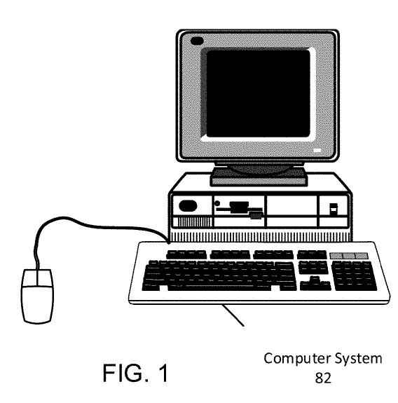

FIG. 1 illustrates an example of a computer system 82 that may execute the graphical programming development environment application (or other software application) that implements the automatic arrangement of objects in a graphical program block diagram. The computer system 82 may include at least one memory medium on which various computer programs, software components, and data structures are stored. In particular, the memory medium may store the graphical programming development environment application, which may be executed by one or more processors of the computer system 82. The memory medium may also store a graphical program. The memory medium may also store operating system software, as well as other software for operation of the computer system.

As described below, the graphical programming development environment may be operable to automatically arrange or position objects within a block diagram of the graphical program. For example, in some embodiments the graphical programming development environment may automatically arrange the objects in the block diagram in response to a user request for the graphical programming development environment to organize the block diagram.

As shown in FIG. 1, the computer system 82 may also include a display device. The block diagram of the graphical program may be displayed on the display device. For example, a plurality of nodes interconnected by a plurality of edges (e.g., lines or wires) may be displayed in the block diagram. The plurality of interconnected nodes may visually indicate functionality of the graphical program. After the graphical programming development environment has automatically arranged or re-positioned the objects in the block diagram, the block diagram may appear differently in the display device. For example, one or more of the objects in the block diagram may be located at different positions than where they were initially.

### Exemplary Systems

In various embodiments, the graphical program whose block diagram objects are automatically arranged according to the method described herein may be a graphical program operable to perform any of various kinds of functions or associated with any of various kinds of application. For example, in various embodiments the graphical program may perform functions such as test and/or measurement functions; controlling and/or modeling instrumentation or industrial automation hardware; modeling and simulation functions, e.g., modeling or simulating a device or product being developed or tested, etc. Other exemplary test applications where the graphical program may be used include hardware-in-the-loop testing and rapid control prototyping, among others.

However, it is noted that in other embodiments the graphical program may be used for any other type of application and is not limited to the above applications. For example, the graphical program may perform a function such as the control of other types of devices such as multimedia devices, video devices, audio devices, telephony devices, Internet devices, etc., as well as general purpose software applications such as word processing, spreadsheets, network control, network monitoring, financial applications, games, etc.

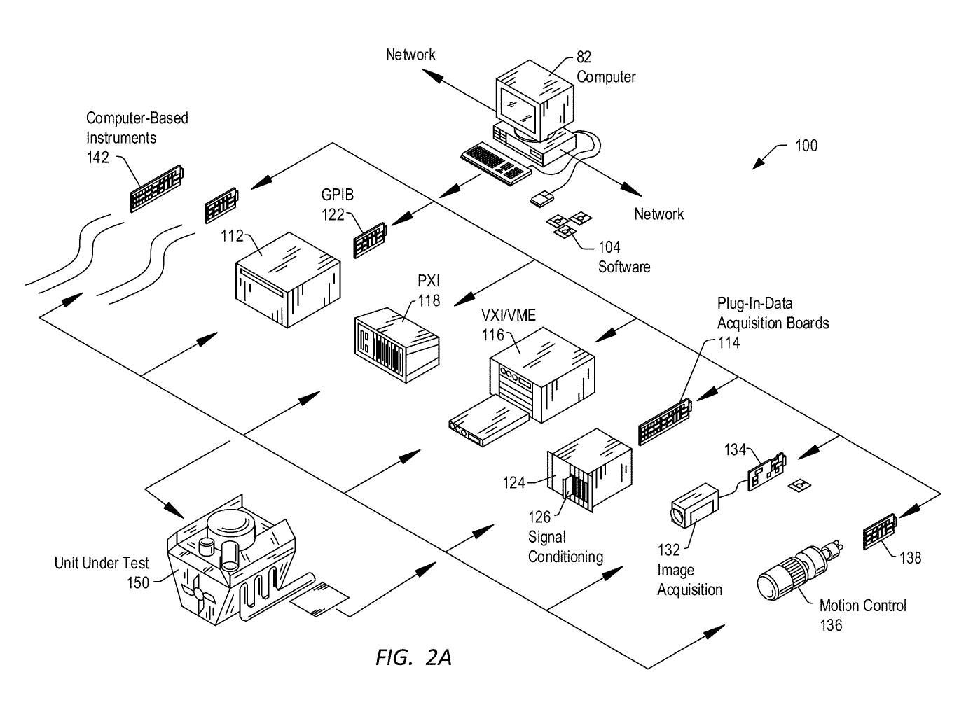

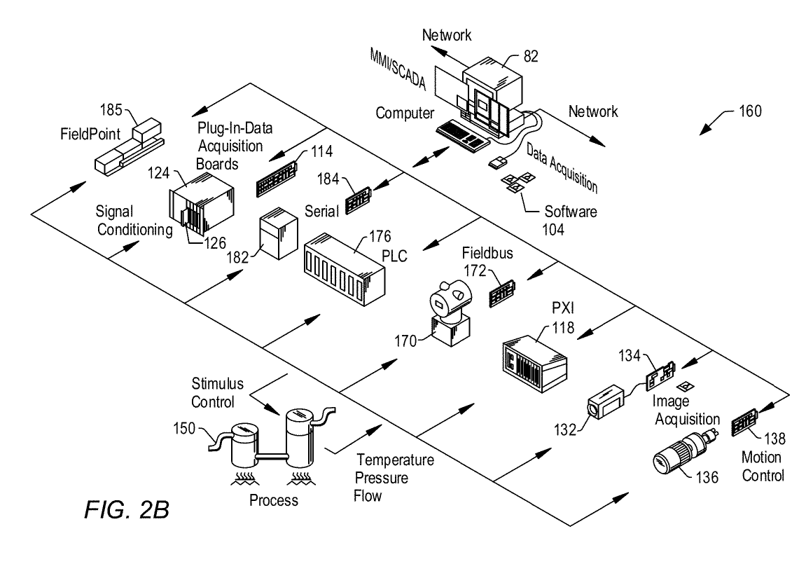

FIG. 2A illustrates an exemplary instrumentation control system 100. The system 100 comprises a host computer 82 that couples to one or more instruments. The host computer 82 may comprise a CPU, a display screen, memory, and one or more input devices such as a mouse or keyboard as shown. In some embodiments the computer 82 may execute the graphical program, wherein the graphical program operates with the one or more instruments to analyze, measure, or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the UUT or process 150, or may be coupled to receive field signals, typically generated by transducers. In various embodiments the graphical program may be used in a data acquisition and control application, a test and measurement application, an image processing or machine vision application, a process control application, a man-machine interface application, a simulation application, or a hardware-in-the-loop validation application, among others.

FIG. 2B illustrates an exemplary industrial automation system 160. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which couples to one or more devices or instruments. The computer 82 may comprise a CPU, a display screen, memory, and one or more input devices such as a mouse or keyboard as shown. In some embodiments the computer 82 may execute the graphical program, where the graphical program operates with the one or more devices to a process or device 150 to perform an automation function, such as MMI (Man Machine Interface), SCADA (Supervisory Control and Data Acquisition), portable or distributed data acquisition, process control, advanced analysis, or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices. In some embodiments of the systems of FIGS. 2A and 2B, one or more of the various devices may couple to each other over a network, such as the Internet.

Graphical programs which perform data acquisition, analysis and/or presentation, e.g., for measurement, instrumentation control, industrial automation, modeling, or simulation, such as in the applications shown in FIGS. 2A and 2B, may be referred to as virtual instruments.

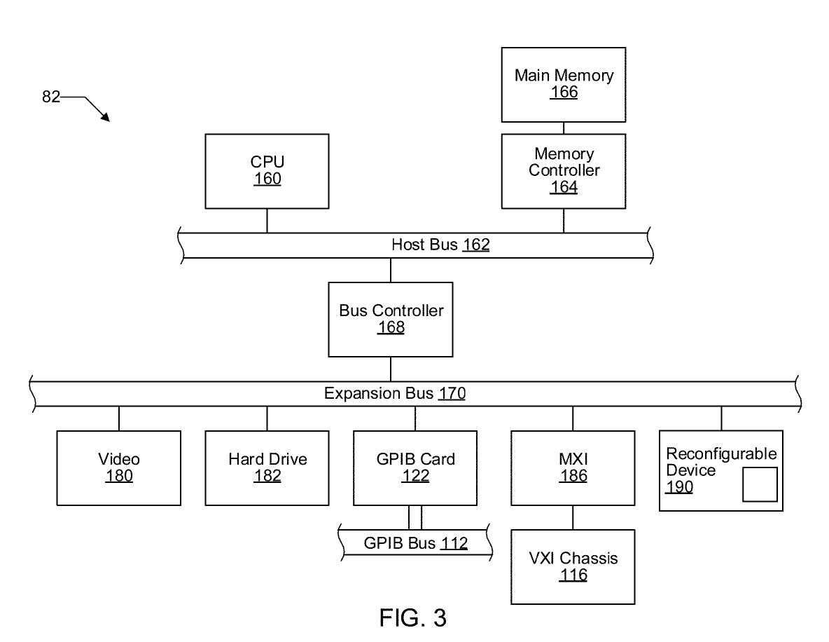

FIG. 3 is a block diagram representing one embodiment of the computer system 82 illustrated in FIGS. 1, 2A, and 2B. It is noted that any type of computer system configuration or architecture can be used as desired, and FIG. 3 illustrates a representative PC embodiment. It is also noted that the computer system may be a general purpose computer system, a computer implemented on a card installed in a chassis, or other types of configurations. Elements of a computer not necessary to understand the present description have been omitted for simplicity.

In this example, the computer system 82 may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory 166, is coupled to the host bus 162 by means of memory controller 164.

The main memory 166 may store the graphical programming development environment and the graphical program, where the graphical programming development environment operates to automatically arrange the objects in the block diagram of the graphical program according to the method described below.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170.

As shown, a device 190 may also be connected to the computer. The device 190 may include a processor and memory which may execute a real time operating system. The device 190 may also or instead comprise a programmable hardware element. In some embodiments the computer system may be operable to deploy a graphical program to the device 190 for execution of the graphical program on the device 190. The deployed graphical program may take the form of graphical program instructions or data structures that directly represents the graphical program. Alternatively, the deployed graphical program may take the form of text code (e.g., C code) generated from the graphical program. As another example, the deployed graphical program may take the form of compiled code generated from either the graphical program or from text code that in turn was generated from the graphical program.

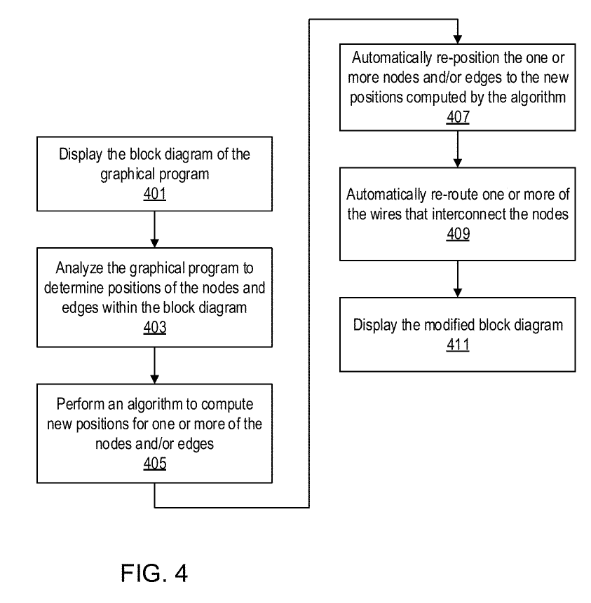

FIG. 4 is a flowchart diagram illustrating one embodiment of a method for automatically organizing a block diagram of a graphical program. The method of FIG. 4 may be implemented by the graphical programming development environment.

As indicated in 401, the block diagram of the graphical program may be displayed, e.g., on the display of the computer 82. For example, the block diagram may display various nodes which the user has included in the graphical program, as well as wires the user has created to connect the nodes.

For various reasons, the block diagram of the graphical program may not be organized particularly well. For example, as the user creates the graphical program, the user does not always know exactly which nodes will be present in the block diagram and how these nodes will be positioned when the graphical program is complete (e.g., because creating the graphical program may be something of an experimental or iterative process). Thus, for example, the user may find that he or she needs to insert a node in a place where he or she originally did not anticipate a node being located. Even if the user does know exactly which nodes will be present in the completed program, the user still may not want to take the time to align and space the nodes with respect to each other in order to form an aesthetically pleasing block diagram.

Thus, the graphical programming development environment may be operable to automatically organize the block diagram for the user. For example, the graphical programming development environment may receive user input requesting the block diagram to be automatically organized. For example, the user may select a menu item or provide other input to request the graphical programming development environment to automatically organize the block diagram.

In some embodiments, the graphical programming development environment may be operable to automatically organize the block diagram for the user in response to an event. For example, the graphical programming development environment may compute an “incremental layout” for the block diagram when its nodes are resized. Similarly, the graphical programming development environment may re-position the objects of the block diagram in response to shrinking nodes and/or nodes being added or deleted.

In response, the graphical programming development environment may automatically analyze the graphical program to determine positions of the nodes and/or edges within the block diagram, as indicated in 403. For example, the graphical programming development environment may traverse data structures representing the graphical program to determine which nodes, edges, and other objects are present, determine how these nodes and edges are connected to each other, determine the original positions of the nodes and edges (e.g., where they are originally located in the block diagram), etc.

In 405, the graphical programming development environment may perform an algorithm to compute new positions for one or more of the nodes and/or edges, e.g., based on the information obtained when the graphical program is analyzed in 403. In various embodiments the graphical programming development environment may use any kind of algorithm to compute the new positions. Exemplary algorithms are described below.

In 407 the graphical programming development environment may automatically re-position the one or more nodes and/or edges to the new positions computed by the algorithm. Thus, the nodes and/or edges may be re-positioned or rearranged within the block diagram without the user providing input to manually move the nodes and/or edges. Also, as indicated in 409, one or more of the edges (e.g., wires) that interconnect the nodes may be automatically re-routed, e.g., to reflect the new positions of the nodes.

As indicated in 411, the graphical programming development environment may display the modified block diagram. In some embodiments the window which displays the original block diagram may be updated after the objects in the block diagram have been re-positioned, e.g., so that the modified block diagram replaces the original block diagram. In other embodiments the modified block diagram may be displayed in a new window.

In other embodiments the modified block diagram may not be immediately displayed all at once. Instead the graphical programming development environment may be operable to display animations so that the user can see how objects in the graphical program have been re-positioned. For example, where a node is re-positioned to a new location, the graphical programming development environment may display an animation of the node moving from its original location to the new location.

In various embodiments the block diagram organization algorithm may re-position nodes and/or in the graphical program in order to achieve any of various goals and according to any of various constraints. For example, the final node positions may be preferably re-positioned and the edges preferably routed in such a way that the final node positions are as close to the original positions as possible. Another constraint may include the final positions, relative to other nodes in the block diagram, are as close to the original relative positions as possible. Another constraint may be that the modified block diagram may preserve as many artifacts (e.g., straight edges, node alignment) of the original block diagram as possible.

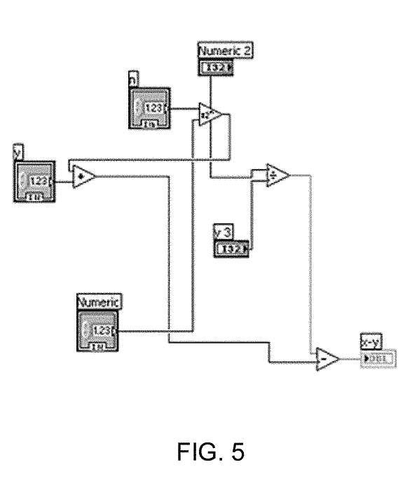

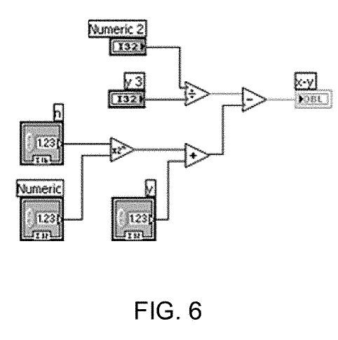

FIG. 5 illustrates an example of a graphical program block diagram before it has been automatically organized by the graphical programming development environment. FIG. 6 illustrates an example of how the block diagram of FIG. 5 may appear after it has been automatically organized by the graphical programming development environment according to one embodiment. It is noted that FIG. 6 illustrates one example of how the block diagram may be automatically re-organized, and in various other embodiments the resulting block diagram may differ in appearance.

It is noted that various embodiments may further include receiving, sending or storing instructions and/or data implemented in accordance with the foregoing description upon a computer-readable memory medium. Generally speaking, a computer-readable memory medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. for storing program instructions. Such a computer-readable memory medium may store program instructions received from or sent on any transmission media or signals such as electrical, electromagnetic, or digital signals, conveyed via a communication medium such as network and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-readable memory medium comprising program instructions for positioning objects in a graphical program, wherein the program instructions are executable to:
display the graphical program on a display, wherein the graphical program includes a plurality of nodes interconnected via a plurality of edges, wherein the plurality of nodes and the plurality of edges visually indicate functionality of the graphical program, and wherein displaying the graphical program comprises displaying the plurality of nodes interconnected via the plurality of edges nodes in a block diagram on the display;
analyze the graphical program to determine positions of the nodes and the edges within the block diagram; and
automatically re-position one or more of the nodes and/or one or more of the edges within the block diagram, based on the determined positions of the nodes and the edges, to create a modified block diagram.

2. The computer-readable memory medium of claim 1, wherein the analyzing the graphical program to determine positions of the nodes and the edges includes determining a respective set of bounds of each node, a respective set of position coordinates of each node, a source of each edge, and an end point of each edge.

3. The computer-readable memory medium of claim 1, wherein the analyzing the graphical program to determine positions of the nodes and the edges further includes determining positions of a plurality of port offsets, including a source port offset and a destination port offset, wherein the port offsets indicate a spatial relationship between a port of a node and an edge that connects to the port of the node.

4. The computer-readable memory medium of claim 3, wherein the determining the positions of a plurality of port offsets includes determining a respective set of position coordinates of each port offset.

5. The computer-readable memory medium of claim 1, wherein the automatically re-positioning is performed according to a plurality of constraints on the modified block diagram.

6. The computer-readable memory medium of claim 5, wherein the plurality of constraints includes minimizing a sum total of movement of the plurality of nodes.

7. The computer-readable memory medium of claim 5, wherein the plurality of constraints includes avoiding overlap of the plurality of nodes.

8. The computer-readable memory medium of claim 5, wherein the plurality of constraints includes preserving a shape of the block diagram.

9. A method, comprising:
displaying, by a computer system, a graphical program on a display, wherein the graphical program includes a plurality of nodes interconnected via a plurality of edges, wherein the plurality of nodes and the plurality of edges visually indicate functionality of the graphical program, and wherein displaying the graphical program comprises displaying the plurality of nodes interconnected via the plurality of edges nodes in a block diagram on the display;
analyzing, by the computer system, the graphical program to determine positions of the nodes and the edges within the block diagram; and
automatically re-positioning, by the computer system, one or more of the nodes and/or one or more of the edges within the block diagram, based on the determined positions of the nodes and the edges, to create a modified block diagram.

10. The method of claim 9, wherein the analyzing the graphical program to determine positions of the nodes and the edges includes determining a respective set of bounds of each node, a respective set of position coordinates of each node, a source of each edge, and an end point of each edge.

11. The method of claim 9, wherein the analyzing the graphical program to determine positions of the nodes and the edges further includes determining positions of a plurality of port offsets, including a source port offset and a destination port offset, wherein the port offsets indicate a spatial relationship between a port of a node and an edge that connects to the port of the node.

12. The method of claim 11, wherein the determining the positions of a plurality of port offsets includes determining a respective set of position coordinates of each port offset.

13. The method of claim 9, wherein the automatically re-positioning is performed according to a plurality of constraints on the modified block diagram.

14. The method of claim 13, wherein the plurality of constraints includes minimizing a sum total of movement of the plurality of nodes.

15. The method of claim 13, wherein the plurality of constraints includes avoiding overlap of the plurality of nodes.

16. The method of claim 13, wherein the plurality of constraints includes preserving a shape of the block diagram.

17. A system, comprising:
a processor; and
a memory coupled to the processor, wherein the memory has program instructions stored thereon that are executable by the system to:
cause the graphical program to be displayed on a display, wherein the graphical program includes a plurality of nodes interconnected via a plurality of edges, wherein the plurality of nodes and the plurality of edges visually indicate functionality of the graphical program, and wherein displaying the graphical program comprises displaying the plurality of nodes interconnected via the plurality of edges nodes in a block diagram on the display;
analyze the graphical program to determine positions of the nodes and the edges within the block diagram; and
automatically re-position one or more of the nodes and/or one or more of the edges within the block diagram, based on the determined positions of the nodes and the edges, to create a modified block diagram.

18. The system of claim 17, wherein the analyzing the graphical program to determine positions of the nodes and the edges includes determining a respective set of bounds of each node, a respective set of position coordinates of each node, a source of each edge, and an end point of each edge.

19. The computer-readable memory medium of claim 17, wherein the analyzing the graphical program to determine positions of the nodes and the edges further includes determining positions of a plurality of port offsets, including a source port offset and a destination port offset, wherein the port offsets indicate a spatial relationship between a port of a node and an edge that connects to the port of the node.

20. The computer-readable memory medium of claim 19, wherein the determining the positions of a plurality of port offsets includes determining a respective set of position coordinates of each port offset.
